(19) United States
(12) Patent Application Publication
(10) Pub. No.: US 2025/0105280 A1
(43) Pub. Date: Mar. 27, 2025

(54) COATED ACTIVE MATERIAL, BATTERY USING SAME, AND METHOD FOR MANUFACTURING COATED ACTIVE MATERIAL

(71) Applicants: Panasonic Holdings Corporation, Osaka (JP); TOYOTA JIDOSHA KABUSHIKI KAISHA, Aichi (JP)

(72) Inventors: Kenta NAGAMINE, Tokyo (JP); Kenji NAGAO, Osaka (JP)

(21) Appl. No.: 18/974,067

(22) Filed: Dec. 9, 2024

Related U.S. Application Data
(63) Continuation of application No. PCT/JP2023/017471, filed on May 9, 2023.

(30) Foreign Application Priority Data
Jun. 10, 2022 (JP) 2022-094641

(51) Int. Cl. H01M 4/525; H01M 4/02; H01M 4/04; H01M 4/36; H01M 10/052; H01M 10/0562

(52) U.S. Cl. CPC H01M 4/525; H01M 4/04; H01M 4/366; H01M 10/052; H01M 10/0562; H01M 2004/021; H01M 2004/028; H01M 2300/008

(57) ABSTRACT

A coated active material of the present disclosure includes a positive electrode active material and a coating material coating at least a portion of a surface of the positive electrode active material. The coating material includes a compound represented by the following composition formula (1) and carbon attributed to a C1s peak having a binding energy of 288.5±1.5 eV. In the formula (1), a, b, and c are each a positive real number, and M is at least one element other than Li or O. In a surface of the coated active material, an atomic percentage X_{C} of the carbon and an atomic percentage X_{M} of the M satisfy a relation represented by the following inequality (2).

$${Li}_{a} {M}_{b} {O}_{c} \qquad ( 1 )$$

$$0.29 \leq {X}_{C} / ( {X}_{M} + {X}_{C} ) \qquad ( 2 )$$

This application is a continuation of PCT/JP2023/017471 filed on May 9, 2023, which claims foreign priority of Japanese Patent Application No. 2022-094641 filed on Jun. 10, 2022, the entire contents of both of which are incorporated herein by reference.

### BACKGROUND OF THE INVENTION

### 1. Field of the Invention

The present disclosure relates to a coated active material, a battery including the coated active material, and a coated active material manufacturing method.

### 2. Description of Related Art

WO 2013/099878 A1 discloses a composite active material including a carbonaceous material.

WO 2015/050031 A1 discloses a coated positive electrode active material including a carbonate.

### SUMMARY OF THE INVENTION

Conventional techniques need to be improved so as to reduce an increase in resistance of a battery in a durability test.

The present disclosure provides a coated active material including:
a positive electrode active material; and
a coating material coating at least a portion of a surface of the positive electrode active material, wherein
the coating material includes a compound represented by the following composition formula (1) and carbon attributed to a C1s peak having a binding energy of 288.5±1.5 eV:

LiₐM_{b}O_{c} (1),

where a, b, and c are each a positive real number, and M is at least one element other than Li or O, and
in a surface of the coated active material, an atomic percentage X_{C} of the carbon and an atomic percentage X_{M} of the M satisfy a relation represented by the following inequality (2):

$$0.29 \leq {X}_{C} / ( {X}_{M} + {X}_{C} ) . \qquad ( 2 )$$

The coated active material of the present disclosure can reduce an increase in resistance of a battery in a durability test.

### BRIEF DESCRIPTION OF THE DRAWINGS

FIG. 1 is a cross-sectional view schematically showing a configuration of a coated active material 130 of Embodiment 1.

FIG. 2 is a cross-sectional view schematically showing a configuration of a positive electrode material 1000 of Embodiment 2.

FIG. 3 is a cross-sectional view schematically showing a configuration of a battery 2000 of Embodiment 3.

FIG. 4 is a graph showing a relation between X_{C}/(X_{Nb}+X_{C}) and an initial resistance and a relation between X_{C}/(X_{Nb}+X_{C}) and a resistance change rate.

FIG. 5 is a graph showing an elemental profile of a coated active material of Comparative Example 1 in the depth direction.

FIG. 6 is a graph showing an elemental profile of a coated active material of Example 4 in the depth direction.

FIG. 7 is a graph showing C1s XPS spectra of coated active materials of Example 6 and Comparative Example 1.

### DETAILED DESCRIPTION

(Findings on which the Present Disclosure is Based)

Although materials used as solid electrolytes have a high ionic conductivity, the materials are chemically so unstable that the materials are likely to be deteriorated when brought into contact with another material. Hence, interfacial design between a solid electrolyte and another material is very important in view of reduction of the resistance of a battery. For example, when a lithium composite oxide and a sulfide solid electrolyte are in direct contact, diffusion of an element occurs near the interface therebetween, forming a deterioration layer. Formation of the deterioration layer is expressed as an increase in resistance of a battery, the increase resulting from charging and discharging of the battery.

A known method for preventing such deterioration is forming a coating layer made of an ion conductive oxide such as lithium niobium oxide on the surface of an active material. This coating layer needs to be uniformly formed at a thickness that does not hinder ionic conduction, for example, at a thickness from several nanometers to several hundred nanometers on the surface of the active material. However, because active materials are particles having asperities on their surfaces and being several micrometers in size, there are limited methods for forming a coating layer on their surfaces. One method is forming a coating layer by mixing an organic metal compound and an active material and sintering the mixture. Another method is forming a coating layer by spraying a solution containing a metal ion on an active material simultaneously with drying. Both of these methods are liquid-phase methods, and thus the coating layer cannot always have a uniform thickness or be present over the entire surface. A coating layer can be formed by a gas phase method such as sputtering; however, in that case, the resulting coating layer will have such an insufficient thickness that it is difficult to achieve a sufficiently high active material protecting effect.

Under such circumstances, the present inventors made intensive studies on a configuration of an active material suitable for reducing an increase in resistance of a battery in a durability test. As a result, the present inventors found that an increase in resistance of a battery in a durability test can be reduced by providing a particular carbon compound on the surface of an active material, and have completed the coated active material of the present disclosure. It should be noted that the term “durability test” refers to, as described in EXAMPLES, a test in which charging and discharging are repeated in a high-temperature atmosphere at a high rate.

### (Summary of One Aspect According to the Present Disclosure)

A coated active material according to a first aspect of the present disclosure includes:
a positive electrode active material; and
a coating material coating at least a portion of a surface of the positive electrode active material, wherein
the coating material includes a compound represented by the following composition formula (1) and carbon attributed to a C1s peak having a binding energy of 288.5±1.5 eV:

LiₐM_{b}O_{c} (1),

where a, b, and c are each a positive real number, and M is at least one element other than Li or O, and
in a surface of the coated active material, an atomic percentage X_{C} of the carbon and an atomic percentage X_{M} of the M satisfy a relation represented by the following inequality (2):

$$0.29 \leq {X}_{C} / ( {X}_{M} + {X}_{C} ) . \qquad ( 2 )$$

The coated active material of the present disclosure can reduce an increase in resistance of a battery in a durability test.

According to a second aspect of the present disclosure, for example, in the coated active material according to the first aspect, the atomic percentage X_{C} and the atomic percentage X_{M} may satisfy a relation represented by the following inequality (3). This configuration can increase the reducing effect on an increase in resistance.

$$0.29 \leq {X}_{C} / ( {X}_{M} + {X}_{C} ) < 0.67 \qquad ( 3 )$$

According to a third aspect of the present disclosure, for example, in the coated active material according to the first or second aspect, the carbon may be distributed in a region extending from a surface of the coated active material to a depth of 50 nm or less. This configuration makes hindrance of ion conduction through the coating material less likely.

According to a fourth aspect of the present disclosure, for example, in the coated active material according to any one of the first to third aspects, the M may be at least one element selected from the group consisting of a metal element and a metalloid element.

According to a fifth aspect of the present disclosure, for example, in the coated active material according to any one of the first to fourth aspects, the M may be in a trivalent state, a tetravalent state, a pentavalent state, or a mixed state of these. This configuration can improve the ion conductivity of the coating material and thus can further reduce the resistance of a battery.

According to a sixth aspect of the present disclosure, for example, in the coated active material according to any one of the first to fifth aspects, the M may include niobium. When the coating material includes niobium, the lithium ion conductivity of the coating material can be improved.

According to a seventh aspect of the present disclosure, for example, in the coated active material according to any one of the first to sixth aspects, the M may include at least one selected from the group consisting of nitrogen, sulfur, and phosphorus. This configuration is likely to make the structure of the coating material amorphous, improving the lithium ion conductivity of the coating material.

According to an eighth aspect of the present disclosure, for example, in the coated active material according to any one of the first to seventh aspects, the positive electrode active material may include a lithium-containing transition metal oxide having a layered rock-salt structure. Excellent charge and discharge characteristics can be achieved by including the above material.

A battery according to a ninth aspect of the present disclosure includes a positive electrode including the coated active material according to any one of the first to eighth aspects.

A battery according to a tenth aspect of the present disclosure includes:
a positive electrode including the coated active material according to any one of the first to eighth aspects;
a negative electrode; and
an electrolyte layer disposed between the positive electrode and the negative electrode.

According to the present disclosure, a battery configured so that an increase in resistance thereof in a durability test is reduced can be provided.

According to an eleventh aspect of the present disclosure, for example, in the battery according to the tenth aspect, the electrolyte layer may include a sulfide solid electrolyte. This configuration can further improve the charge and discharge efficiency of the battery.

A coated active material manufacturing method according to a twelfth aspect of the present disclosure includes:
coating a positive electrode active material with a coating material; and
bringing the positive electrode active material coated with the coating material into contact with a treatment gas including carbonic acid gas at a higher concentration than in air.

According to the manufacturing method of the present disclosure, the concentration of carbon contained in the carbonate ion in a surface portion of the positive electrode active material coated with the coating material can be increased.

According to a thirteenth aspect of the present disclosure, for example, the coated active material manufacturing method according to the twelfth aspect may further include heating the positive electrode active material coated with the coating material while the positive electrode active material is in contact with the treatment gas. The concentration of the carbon contained in the carbonate ion in the surface portion of the positive electrode active material coated with the coating material can be efficiently increased by the heating.

According to a fourteenth aspect of the present disclosure, for example, in the coated active material manufacturing method according to the twelfth or thirteenth aspect, a main component of the treatment gas may be the carbonic acid gas. The carbonate ion concentration in the surface portion of the positive electrode active material coated with the coating material can be efficiently increased by using the carbonic acid gas.

Embodiments of the present disclosure will be described hereinafter with reference to the drawings. The present disclosure is not limited to the following embodiments.

### Embodiment 1

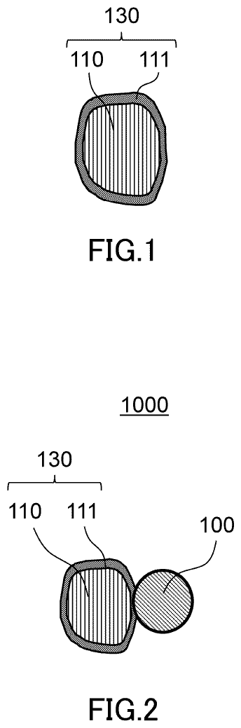

FIG. 1 is a cross-sectional view schematically showing a configuration of a coated active material 130 of Embodiment 1.

The coated active material 130 includes a positive electrode active material 110 and a coating material 111. The coating material 111 coats at least a portion of a surface of the positive electrode active material 110. The shape of the positive electrode active material 110 is, for example, a particle. The shape of the coating material 111 is, for example, a layer. The coating material 111 includes a compound represented by the following composition formula (1) and carbon attributed to a C1s peak having a binding energy of 288.5±1.5 eV. The C1s peak is a peak appearing in an X-ray photoelectron spectroscopy (XPS) spectrum. The carbon attributed to a C1s peak having a binding energy of 288.5±1.5 eV is carbon contained in the carbonate ion (CO₃²⁻). In the formula (1), a, b, and c are each a positive real number, and M is at least one element other than Li or O. In a surface of the coated active material 130, an atomic percentage X_{C} of the carbon contained in the carbonate ion and an atomic percentage X_{M} of the M satisfy a relation represented by the following inequality (2).

$${Li}_{a} {M}_{b} {O}_{c} \qquad ( 1 )$$

$$0.29 \leq {X}_{C} / ( {X}_{M} + {X}_{C} ) \qquad ( 2 )$$

Herein, the layer including the carbon contained in the carbonate ion is sometimes referred to as “carbonate layer”.

The carbon contained in the carbonate ion is present in the surface of the coated active material 130. Specifically, the coating material 111 includes the carbon contained in the carbonate ion. This configuration allows the carbon contained in the carbonate ion to prevent contact between the positive electrode active material 110 and a solid electrolyte in a positive electrode even when there is a defect that cannot be prevented from forming in the sole presence of the compound represented by the formula (1) or the coating made of the compound represented by the formula (1) is partially thin. Consequently, an increase in resistance of a battery in a durability test can be reduced.

Carbon included in an organic substance, graphite, amorphous carbon, or the like does not exhibit the above effect because such carbon causes oxidative decomposition during operation of a battery or deterioration of a solid electrolyte due to electron conduction.

The carbon contained in the carbonate ion may have insulation properties.

Additionally, in the case where the carbon contained in the carbonate ion is present only between the positive electrode active material and the coating material, it is difficult to control the amount of carbon adhered and the thickness of a region where carbon is distributed. As a result, against expectations, carbon becomes a factor hindering ionic conduction or fails to offer sufficient protection performance. For example, it is known that lithium carbonate and/or lithium hydrogen carbonate is present as a residual alkaline component at a surface of a composite oxide including lithium and a transition metal. However, lithium carbonate and/or lithium hydrogen carbonate as a residual alkaline component has insufficient protection performance because the amount of carbon adhered and the thickness of a region where carbon is distributed are not controlled. Additionally, since a compound referred to as lithium hydrogen carbonate is indefinite in shape, a Li₂O—H₂O—CO₂ ratio therein can be any ratio. If H₂O occupies a large proportion, lithium hydrogen carbonate may be electrochemically or thermally decomposed to worsen the properties of a battery.

The inequality (2) specifying the lower limit of the value of X_{C}/(X_{M}+X_{C}) is provided to exclude carbon derived from carbon dioxide in air.

The atomic percentage X_{C} and the atomic percentage X_{M} may satisfy a relation represented by the following inequality (3). This configuration can increase the reducing effect on an increase in resistance.

$$0.29 \leq {X}_{C} / ( {X}_{M} + {X}_{C} ) < 0.67 \qquad ( 3 )$$

When the value of X_{C}/(X_{M}+X_{C}) is less than 0.67, the coating material 111 includes an appropriate amount of carbon. In that case, ionic conduction between the positive electrode active material 110 and a solid electrolyte in a positive electrode is not likely to be hindered, and thus an increase in resistance can be reduced more effectively. As the value of X_{C}/(X_{M}+X_{C}) is 0.29 or more and less than 0.67, a good balance between the protection performance and the ion conductivity of the coating material 111 can be achieved.

The atomic percentage X_{C} and the atomic percentage X_{M} may satisfy a relation represented by the following inequality (4). This configuration can further increase the reducing effect on an increase in resistance.

$$0.29 \leq {X}_{C} / ( {X}_{M} + {X}_{C} ) \leq 0.6 \qquad ( 4 )$$

The atomic percentage X_{C} and the atomic percentage X_{M} may satisfy a relation represented by the following inequality (5). This configuration can further increase the reducing effect on an increase in resistance.

$$0.29 \leq {X}_{C} / ( {X}_{M} + {X}_{C} ) \leq 0.58 \qquad ( 5 )$$

The atomic percentage X_{C} refers to an atomic percentage (unit: atomic %) of the carbon contained in the carbonate ion with respect to all elements in the surface of the coated active material 130. Likewise, the atomic percentage X_{M} refers to an atomic percentage (unit: atomic %) of the element M with respect to all elements in the surface of the coated active material 130. The term “surface” does not necessarily mean the outermost surface, and means a region having a thickness of several nanometers which corresponds to an escape depth of a photoelectron in XPS measurement.

The atomic percentage X_{C} of the carbon contained in the carbonate ion and the atomic percentage X_{M} of the M in the surface of the coated active material 130 can be determined by X-ray photoelectron spectroscopy (XPS).

The atomic percentage X_{C} of carbon can be calculated from peaks attributed to C1s. The peaks attributed to C1s appear in the binding energy range of 282 eV to 291 eV in an XPS spectrum. In the binding energy range of 282 eV to 291 eV, a peak around 288.5±1.5 eV is a peak attributed to carbon having a bond derived from the carbonate ion. A peak around 285 eV is a peak attributed to carbon having another bond. Hence, first, a total atomic percentage X_{Ctot} of carbon is calculated from the peaks appearing in the binding energy range of 282 eV to 291 eV. Next, peak fitting of the C1s peaks is performed using the pseudo-Voigt function to separate the peak attributed to the carbon contained in the carbonate ion and the peak attributed to another carbon. The atomic percentage X_{C} of the carbon contained in the carbonate ion can be determined by an equation X_{C}=X_{Ctot}×r_{C1}, where r_{C1} represents a proportion of the area of the peak attributed to the carbon contained in the carbonate ion in the total area of the C1s peaks.

The atomic percentage X_{M} of M can be measured in a binding energy range that is typical for an element, such as a metal or metalloid element, included in the coating material 111. For example, a peak attributed to Nb3d is present in the binding energy range of 200 eV to 212 eV in an XPS spectrum. An atomic percentage X_{Nb} of Nb can be calculated using the Nb3d peak.

An influence of electrification in XPS measurement may be corrected by designating a peak on the lowest binding energy side of C1s as 285 eV.

The carbon contained in the carbonate ion may be distributed in a region extending from the surface of the coated active material 130 to a depth of 50 nm or less. In other words, the carbonate layer being the layer including the carbon contained in the carbonate ion may have a thickness of 50 nm or less from the surface of the coated active material 130 toward the inside thereof. Limiting the thickness of the carbonate layer to 50 nm or less makes hindrance of ion conduction through the coating material 111 less likely. This contributes to reduction of the resistance of a battery and reduction of an increase in resistance in a durability test. A profile of carbon in the depth direction can be obtained by repeating argon etching and XPS measurement. The thickness of the carbonate layer can be calculated in terms of SiO₂ thickness under etching conditions determined by argon etching of a thin SiO₂ film having a known thickness.

In an XPS spectrum, a peak around 285 eV is a peak derived from carbon having a C—C bond. This carbon may be carbon derived from an oil for a vacuum pump used in XPS measurement or carbon derived from a carbon tape used to fix a specimen. A peak around 288.5 eV is a peak of carbon having an O—C═O bond, namely, the carbon contained in the carbonate ion.

The M in LiₐM_{b}O_{c} being the compound included in the coating material 111 can be at least one element selected from the group consisting of a metal element and a metalloid element. This configuration can improve the lithium ion conductivity of the coating material 111 and can reduce the resistance of a battery.

The M in LiₐM_{b}O_{c} being the compound included in the coating material 111 can be in a trivalent state, a tetravalent state, a pentavalent state, or a mixed state of these. This configuration can improve the ion conductivity of the coating material 111 and thus can further reduce the resistance of a battery.

When the M is a polyvalent ion having a valence of three or more, an oxide ion in the coating material 111 and the polyvalent ion M are bonded more strongly and thus a bond between a lithium ion and the oxide ion can be weakened. Consequently, the lithium ion conductivity of the coating material 111 can be improved.

Examples of the compound included in the coating material 111, namely the compound represented by the formula (1), include Li—Nb—O compounds such as LiNbO₃, Li—B—O compounds such as LiBO₂ and Li₃BO₃, Li—Al—O compounds such as LiAlO₂, Li—Si—O compounds such as Li₄SiO₄, Li—Ti—O compounds such as Li₂SO₄ and Li₄Ti₅O₁₂, Li—Zr—O compounds such as Li₂ZrO₃, Li—Mo—O compounds such as Li₂MoO₃, Li-V-O compounds such as LiV₂O₅, Li—W—O compounds such as Li₂WO₄, Li—P—O compounds such as Li₃PO₄, Li—N—O compounds such as LiNO₃, and Li—S—O compounds such as Li₂SO₃. One selected from these compounds may be used alone, or two or more of these compounds may be used in combination.

The M in the compound represented by the formula (1) may include niobium. That is, the coating material 111 may include a composite oxide of lithium and niobium. When the coating material 111 includes niobium, the lithium ion conductivity of the coating material 111 can be improved and the resistance of a battery can be reduced.

The M in the compound represented by the formula (1) may include at least one selected from the group consisting of nitrogen, sulfur, and phosphorus. That is, the compound represented by the formula (1) may include at least one selected from the group consisting of a Li—P—O compound such as Li₃PO₄, a Li—N—O compound such as LiNO₃, and a Li—S—O compound such as Li₂SO₃. The coating material 111 including at least one selected from the group consisting of nitrogen, sulfur, and phosphorus is likely to have an amorphous structure, and thus the lithium ion conductivity of the coating material 111 improves. Consequently, the resistance of a battery can be reduced.

The layer including the coating material 111 may have a thickness of 0.1 nm or more and 100 nm or less. The layer including the coating material 111 having a thickness of 0.1 nm or more sufficiently reduces direct contact between the positive electrode active material 110 and a solid electrolyte in a positive electrode of a battery and can suppress a side reaction of the solid electrolyte. Consequently, the charge and discharge efficiency of a battery is improved. The layer including the coating material 111 having a thickness of 100 nm or less is not too thick and thus can sufficiently reduce the internal resistance of a battery. Consequently, the energy density of the battery can be increased.

The layer including the coating material 111 may have a thickness of 1 nm or more and 40 nm or less. The layer including the coating material 111 having a thickness of 1 nm or more sufficiently reduces direct contact between the positive electrode active material 110 and a solid electrolyte and can suppress a side reaction of the solid electrolyte. Consequently, the charge and discharge efficiency of a battery is improved. The layer including the coating material 111 having a thickness of 40 nm or less can more sufficiently reduce the internal resistance of a battery. Consequently, the energy density of the battery can be increased.

The method for measuring the thickness of the layer including the coating material 111 is not limited to a particular one. For example, the thickness can be estimated by etching the surface of the coated active material 130 by ion beam etching and simultaneously observing a particular peak attributed to the coating material 111 in XPS measurement. Alternatively, the thickness of the layer including the coating material 111 may be measured by direct observation using a transmission electron microscope.

The coating material 111 may coat the entire surface of the positive electrode active material 110 in the shape of a particle. This configuration reduces direct contact between the positive electrode active material 110 and particles of a solid electrolyte and thus can suppress a side reaction of the solid electrolyte. Hence, the charge and discharge efficiency can be improved.

Alternatively, the coating material 111 may coat only a portion of the surface of the positive electrode active material 110 in the shape of a particle. Direct contact between the plurality of particles of the positive electrode active material 110 on their portions not coated with the coating material 111 improves the electron conductivity between the particles of the positive electrode active material 110. Hence, a battery can operate at high power.

The positive electrode active material 110 includes a material having properties of occluding and releasing metal ions (e.g., lithium ions). As the positive electrode active material 110 can be used a lithium-containing transition metal oxide, a transition metal fluoride, a polyanion material, a fluorinated polyanion material, a transition metal sulfide, a transition metal oxysulfide, a transition metal oxynitride, etc. It is possible to reduce a manufacturing cost and increase the average discharge voltage particularly by using a lithium-containing transition metal oxide as the positive electrode active material 110.

The positive electrode active material 110 may include a lithium-containing transition metal oxide having a layered rock-salt structure. Insertion and extraction of lithium is easy for the lithium-containing transition metal oxide having a layered rock-salt structure, and the lithium-containing transition metal oxide having a layered rock-salt structure has a large capacity per unit weight. Excellent charge and discharge characteristics can be achieved by using such a material.

Examples of the lithium-containing transition metal oxide having a layered rock-salt structure include lithium nickel cobalt aluminum oxide, lithium nickel cobalt manganese oxide, and lithium cobalt oxide. The positive electrode active material 110 may include a single active material or may include a plurality of active materials having different compositions from each other.

The positive electrode active material 110 may include at least one selected from the group consisting of lithium nickel cobalt aluminum oxide and lithium nickel cobalt manganese oxide. The positive electrode active material 110 may be lithium nickel cobalt aluminum oxide, or may be lithium nickel cobalt manganese oxide. The positive electrode active material 110 may be, for example, Li(NiCoAl)O₂. The positive electrode active material 110 may be, for example, Li(NiCoMn)O₂. Such a configuration can further increase the energy density and the charge and discharge efficiency of a battery.

An electron conductivity of the positive electrode active material 110 at room temperature (25° C.) may be 10⁻⁹ Scm⁻¹ or more, 10⁻⁸ Scm⁻¹ or more, 10⁻⁷ Scm⁻¹ or more, 10⁻⁶ Scm⁻¹ or more, 10⁻⁵ Scm⁻¹ or more, or 10⁻⁴ Scm⁻¹ or more. In the case where the positive electrode active material 110 has a high electron conductivity, an oxidation reaction of a solid electrolyte tends to be promoted in a positive electrode of a battery. The technique of the present disclosure is more effective in such a case.

The positive electrode active material 110 has, for example, the shape of a particle. The shape of the particle of the positive electrode active material 110 is not limited to a particular shape. The shape of the particle of the positive electrode active material 110 can be the shape of a sphere, an ellipsoid, a flake, or a fiber.

The coated active material 130 can be manufactured, for example, by the method described below.

First, the positive electrode active material 110 is prepared. A powder of the positive electrode active material 110 is commercially available.

Next, the positive electrode active material 110 is coated with the coating material. The coating method is not limited to a particular one. Examples of the method for coating the positive electrode active material 110 with the coating material include a liquid phase coating method and a gas phase coating method.

For example, according to the liquid phase coating method, a precursor solution of the coating material is applied to the surface of the positive electrode active material 110. For example, for production of the coating material including lithium niobium oxide, the precursor solution can be a complex solution containing a peroxo complex ([Nb(O₂)₄]³⁻) of niobium and a lithium ion. The complex solution is obtained, for example, by preparing a transparent solution using a hydrogen peroxide solution, niobic acid, and ammonia water and adding a lithium compound to the transparent solution. Examples of the lithium compound include LiOH, LiNO₃, and Li₂SO₄.

The method for applying the precursor solution to the surface of the positive active material 110 is not limited to a particular one. For example, a tumbling fluidized bed granulation coating apparatus can be used to apply the precursor solution to the surface of the positive active material 110. A tumbling fluidized bed granulation coating apparatus can spray the precursor solution on the positive active material 110 to apply the precursor solution to the surface of the positive active material 110 while rolling and fluidizing the positive active material 110. In this manner, a precursor film is formed on the surface of the positive electrode active material 110. Next, the precursor film is dried. The formation and the drying of the precursor film may be performed simultaneously. The positive electrode active material 110 coated with the lithium niobium oxide is obtained in this manner. The drying conditions are, for example, a dry air atmosphere, an atmospheric temperature of 200° C. to 300° C., and 10 minutes or longer and 720 minutes or shorter.

The coating material 111 can be formed by what is called a sol-gel process. That is, the precursor solution may be a mixed solution (sol solution) containing a solvent, a lithium alkoxide, and a niobium alkoxide. Examples of the lithium alkoxide include lithium ethoxide. Examples of the niobium alkoxide include niobium ethoxide. The solvent is, for example, an alcohol such as ethanol. The amount of the lithium alkoxide and that of the niobium alkoxide are adjusted according to a target composition of the coating material. Water may be added to the precursor solution, if needed. The precursor solution may be acidic or alkaline.

Examples of the gas phase coating method include pulsed laser deposition (PLD), vacuum deposition, sputtering, thermal chemical vapor deposition (CVD), and plasma-enhanced chemical vapor deposition. For example, in the PLD, an ion-conducting material serving as a target is irradiated with a high-energy pulsed laser (e.g., a KrF excimer laser with a wavelength of 248 nm) to deposit the sublimed ion-conducting material on the surface of the active material 110. For formation of a layer including LiNbO₃, densely sintered LiNbO₃ is used as the target.

Next, a carbonic acid treatment is performed for the positive electrode active material 110 coated with the coating material. Specifically, the positive electrode active material 110 coated with the coating material is brought into contact with (is exposed to) a treatment gas including carbonic acid gas at a higher concentration than in air. By this method, the concentration of the carbon contained in the carbonate ion can be increased in the surface portion of the positive electrode active material 110 coated with the coating material.

The carbonic acid treatment time is, for example, 10 minutes or longer and 720 minutes or shorter.

The carbonic acid treatment may be performed at ordinary temperature (20° C.±15° C.), or may be performed at a temperature higher than the ordinary temperature. That is, in the carbonic acid treatment, the positive electrode active material 110 coated with the coating material may be heated while the positive electrode active material 110 is in contact with the treatment gas. The concentration of the carbon contained in the carbonate ion in the surface portion of the positive electrode active material 110 coated with the coating material can be efficiently increased by the heating. An ambient temperature during the heating is, for example, 50° C. or higher and 300° C. or lower, and is desirably 100° C. or higher and 300° C. or lower. The concentration of the carbon contained in the carbonate ion can be controlled as appropriate by adjusting the heating temperature as appropriate.

In the carbonic acid treatment, the treatment gas can include carbonic acid gas as a main component. In this case, the concentration of the carbonate ion in the surface portion of the positive electrode active material 110 coated with the coating material can be efficiently increased. Typically, pure carbonic acid gas can be used as the treatment gas. The term “main component” refers to a component whose content is highest on a volume basis.

The coated active material 130 is obtained through the above steps.

### Embodiment 2

FIG. 2 is a cross-sectional view schematically showing a configuration of a positive electrode material 1000 of Embodiment 2. The positive electrode material 1000 is a mixture of the coated active material 130 of Embodiment 1 and a solid electrolyte 100.

The positive electrode material 1000 includes the coated active material 130 and the solid electrolyte 100. The coated active material 130 and the solid electrolyte 100 are in contact with each other.

The solid electrolyte 100 may include at least one selected from the group consisting of a sulfide solid electrolyte, a halide solid electrolyte, and an oxyhalide solid electrolyte. Such a configuration can improve the ionic conductivity of the solid electrolyte 100. Consequently, an increase in resistance of a battery can be reduced. Examples of the halide solid electrolyte include Li₃YX₆, Li₂MgX₄, Li₂FeX₄, Li(Al,Ga,In)X₄, and Li₃(Al,Ga,In)X₆.

Examples of the oxyhalide solid electrolyte include Liₐ(Ta,Nb)_{b}O_{c}X_{d}. The symbols a, b, c, and d are each a value greater than 0. The element X include at least one selected from the group consisting of F, Cl, Br, and I.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. LiX, Li₂O, MO_{q}, LiₚMO_{q}, or the like may be added to these sulfide solid electrolytes. Here, the element X in “LiX” is at least one selected from the group consisting of F, Cl, Br, and I. The element M in “MO_{q}” and “LiₚMO_{q}” is at least one selected from the group consisting of P, Si, Ge, B, Al, Ga, In, Fe, and Zn. The symbols p and q in “MO_{q}” and “LiₚMO_{q}” are each independently a natural number.

The solid electrolyte 100 may include two or more selected from the above materials. The solid electrolyte 100 may include, for example, the halide solid electrolyte and the sulfide solid electrolyte.

In the present disclosure, an expression, for example, “(Al, Ga, I)” in a formula refers to at least one element selected from the group of elements in the parentheses. In other words, the expression “(Al, Ga, In)” is synonymous with the expression “at least one selected from the group consisting of Al, Ga, and In”. The same applies to other elements.

The shape of the solid electrolyte 100 is not limited to a particular one, and may be, for example, the shape of a needle, a sphere, an ellipsoid, or the like. For example, the solid electrolyte 1000 may have the shape of a particle.

For example, when the solid electrolyte 100 has the shape of a particle (e.g., a sphere), the median size of the solid electrolyte 100 may be 100 μm or less. When the median size of the solid electrolyte 100 is 100 μm or less, the coated active material 130 and the solid electrolyte 100 are likely to be in a favorable dispersion state in the positive electrode material 1000. This improves the charge and discharge characteristics of a battery. In Embodiment 1, the median size of the solid electrolyte 100 may be 10 μm or less.

The above configuration allows the coated active material 130 and the solid electrolyte 100 to be in a favorable dispersion state in the positive electrode material 1000.

The median size of the solid electrolyte 100 may be smaller than that of the coated active material 130.

The above configuration allows the solid electrolyte 100 and the coated active material 130 to be in a more favorable dispersion state in the positive electrode material 1000.

The median size of the coated active material 130 may be 0.1 μm or more and 100 μm or less.

When the median size of the coated active material 130 is 0.1 μm or more, the coated active material 130 and the solid electrolyte 100 are likely to be in a favorable dispersion state in the positive electrode material 1000. This improves the charge and discharge characteristics of a battery.

When the median size of the coated active material 130 is 100 μm or less, the diffusion rate of lithium in the coated active material 130 is sufficiently ensured. Hence, a battery can operate at high power.

The median size of the coated active material 130 may be greater than the median size of the solid electrolyte 100. This allows the coated active material 130 and the solid electrolyte 100 to be in a favorable dispersion state.

In the positive electrode material 1000, the particles of the solid electrolyte 100 and the particles of the coated active material 130 may be in contact with each other as shown in FIG. 2. The solid electrolyte 100 may fill a gap between the particles of the coated active material 130. In this case, the coating material 111 and the solid electrolyte 100 are in contact with each other.

The positive electrode material 1000 may include a plurality of particles of the solid electrolyte 100 and a plurality of particles of the coated active material 130.

The amount of the solid electrolyte 100 and the amount of the coated active material 130 may be the same or may be different in the positive electrode material 1000.

The term “median size” herein means a particle size at 50% in a volume-based cumulative particle size distribution. The volume-based particle size distribution is measured, for example, using a laser diffraction measurement apparatus or an image analyzer.

### Embodiment 3

Embodiment 3 will be hereinafter described. The description overlapping with that of Embodiment 1 is omitted as appropriate.

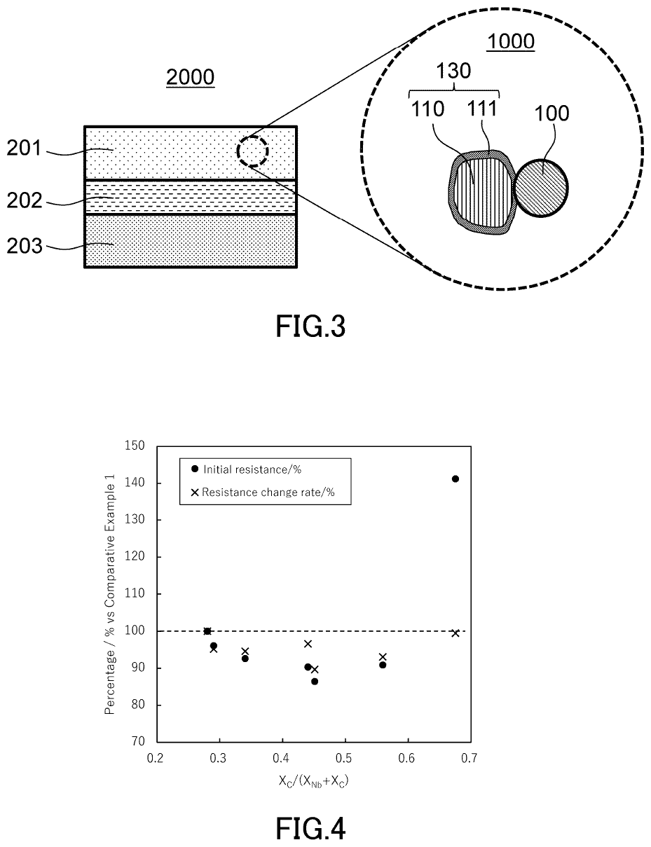

FIG. 3 is a cross-sectional view schematically showing a configuration of a battery 2000 of Embodiment 3.

The battery 2000 includes a positive electrode 201, an electrolyte layer 202, and a negative electrode 203.

The positive electrode 201 includes the positive electrode material 1000 of Embodiment 1. The advantages described in Embodiment 1 are valid for the positive electrode 201.

The electrolyte layer 202 is disposed between the positive electrode 201 and the negative electrode 203.

The above configuration can improve the charge and discharge efficiency of the battery 2000.

The positive electrode 201 may have a thickness of 10 μm or more and 500 μm or less. When the positive electrode 201 has a thickness of 10 μm or more, a sufficient energy density of the battery 2000 is ensured. When the positive electrode 201 has a thickness of 500 μm or less, operation at high power is achievable.

The electrolyte layer 202 is a layer including an electrolyte. The electrolyte is, for example, a solid electrolyte. That is, the electrolyte layer 202 may be a solid electrolyte layer. Hereinafter, the solid electrolyte 100 included in the positive electrode material 1000 may be referred to as “first solid electrolyte”, and the solid electrolyte included in the electrolyte layer 202 may be referred to as “second solid electrolyte”.

The materials mentioned in Embodiment 2 as examples may be used as the material of the second solid electrolyte. That is, the electrolyte layer 202 may include a solid electrolyte having the same composition as that of the solid electrolyte 100 included in the positive electrode material 1000. The electrolyte layer 202 may include, for example, a sulfide solid electrolyte.

The above configuration can further improve the charge and discharge efficiency of the battery 2000.

Alternatively, the electrolyte layer 202 may include a solid electrolyte having a composition different from that of the solid electrolyte 100 included in the positive electrode material 1000. For example, the electrolyte layer 202 may include a sulfide solid electrolyte having a composition different from that of the solid electrolyte 100.

The above configuration can improve the output density and the charge and discharge efficiency of the battery 2000.

The electrolyte layer 202 may include at least one selected from the group consisting of a halide solid electrolyte, an oxyhalide solid electrolyte, an oxide solid electrolyte, a polymer solid electrolyte, and a complex hydride solid electrolyte. The materials mentioned as examples in Embodiment 2 may be used as the halide solid electrolyte and the oxyhalide solid electrolyte.

Examples of the oxide solid electrolyte can include: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, LiGeO₄ and element-substituted substances thereof; a garnet solid electrolyte typified by Li₂La₃Zr₂O₁₂ and element-substituted substances thereof; Li₃N and H-substituted substances thereof; Li₃PO₄ and N-substituted substances thereof; and a glass or glass ceramic including a base material that includes a Li—B—O compound such as LiBO₂ or Li₃BO₃ and to which a material such as Li₂SO₄, or Li₂CO₃ has been added.

For example, a compound of a polymer compound and a lithium salt can be used as the polymer solid electrolyte. The polymer compound may have an ethylene oxide structure. A polymer compound having an ethylene oxide structure can contain a large amount of a lithium salt, and thus can further increase the ionic conductivity. Examples of the lithium salt can include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone, or a mixture of two or more lithium salts selected from these may be used.

For example, LiBH₄—LiI or LiBH₄—P₂S₅ can be used as the complex hydride solid electrolyte.

The electrolyte layer 202 may include the second solid electrolyte as its main component. That is, the second solid electrolyte may account for 50% or more in mass (namely, 50 mass % or more) of a total mass of the electrolyte layer 202.

The above configuration can further improve the charge and discharge characteristics of the battery 2000.

The second solid electrolyte may account for 70% or more in mass (namely, 70 mass % or more) of the total mass of the electrolyte layer 202.

The above configuration can further improve the charge and discharge characteristics of the battery 2000.

The electrolyte layer 202 may include the second solid electrolyte as its main component and may further include: inevitable impurities; or a starting material used for synthesis of the second solid electrolyte, a by-product, a decomposition product, etc.

The second solid electrolyte may account for 100% in mass (namely, 100 mass %) of the total mass of the electrolyte layer 202, except for the inevitable impurities.

The above configuration can further improve the charge and discharge characteristics of the battery 2000.

As described above, the electrolyte layer 202 may consist of the second solid electrolyte.

The electrolyte layer 202 may include only one solid electrolyte selected from the above solid electrolyte group, or may include two or more solid electrolytes selected from the above solid electrolyte group. The plurality of solid electrolytes have different compositions from each other. For example, the electrolyte layer 202 may include the halide solid electrolyte and the sulfide solid electrolyte.

The electrolyte layer 202 may have a thickness of 1 μm or more and 300 μm or less. When the electrolyte layer 202 has a thickness of 1 μm or more, the positive electrode 201 and the negative electrode 203 can be more reliably separated. When the electrolyte layer 202 has a thickness of 300 μm or less, operation at high power can be achieved.

The negative electrode 203 includes a material having properties of occluding and releasing metal ions (e.g., lithium ions). The negative electrode 203 includes, for example, a negative electrode active material.

A metal material, a carbon material, an oxide, a nitride, a tin compound, a silicon compound, or the like can be used as the negative electrode active material. The metal material may be a single-element metal. Alternatively, the metal material may be an alloy. Examples of the metal material include lithium metal and a lithium alloy. Examples of the carbon material include natural graphite, coke, semi-graphitized carbon, carbon fibers, spherical carbon, artificial graphite, and amorphous carbon. In terms of the capacity density, silicon (Si), tin (Sn), a silicon compound, or a tin compound can be used.

The negative electrode 203 may include a solid electrolyte (third solid electrolyte). Such a configuration increases the lithium ion conductivity inside the negative electrode 203 and allows operation at high power. The materials mentioned above may be used as the solid electrolyte.

The median size of the particles of the negative electrode active material may be 0.1 μm or more and 100 μm or less. When the median size of the particles of the negative electrode active material is 0.1 μm or more, the particles of the negative electrode active material and the solid electrolyte can be in a favorable dispersion state in the negative electrode 203. This improves the charge and discharge characteristics of the battery 2000. When the median size of the particles of the negative electrode active material is 100 μm or less, diffusion of lithium in the particles of the negative electrode active material is fast. Hence, the battery 2000 can operate at high power.

The median diameter of the negative electrode active material may be greater than the median size of the solid electrolyte included in the negative electrode 203. This allows the negative electrode active material and the solid electrolyte to be in a favorable dispersion state.

When a volume ratio between the negative electrode active material and the solid electrolyte in the negative electrode 203 is represented by “v2:100-v2”, the volume rate v2 of the negative electrode active material may satisfy 30≤v2≤95. When 30≤v2 is satisfied, a sufficient energy density of the battery 2000 is ensured. When v2≤95 is satisfied, operation at high power is achievable.

The negative electrode 203 may have a thickness of 10 μm or more and 500 μm or less. When the negative electrode 203 has a thickness of 10 μm or more, a sufficient energy density of the battery 2000 is ensured. When the negative electrode 203 has a thickness of 500 μm or less, operation at high power is achievable.

At least one of the positive electrode 201, the electrolyte layer 202, and the negative electrode 203 may include a binder to improve the adhesion between the particles. The binder is used to improve the binding properties of the materials of an electrode. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. As the binder can also be used a copolymer of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from these may be used as the binder.

At least one of the positive electrode 201 and the negative electrode 203 may include a conductive additive to increase the electron conductivity. As the conductive additive can be used, for example, graphites such as natural graphite and artificial graphite; carbon blacks such as acetylene black and ketjen black; conductive fibers such as a carbon fiber and a metal fiber; metal powders such as a fluorinated carbon powder and an aluminum powder; conductive whiskers such as a zinc oxide whisker and a potassium titanate whisker; conductive metal oxides such as titanium oxide; and conductive polymer compounds such as polyaniline, polypyrrole, and polythiophene. Using a conductive carbon additive can seek cost reduction.

The battery 2000 of Embodiment 3 can be configured as batteries of various shapes such as a coin type, a cylindrical type, a prismatic type, a sheet type, a button type, a flat type, and a layer-built type.

### EXAMPLES

Hereinafter, the details of the present disclosure will be described with reference to examples and comparative examples.

### Example 1

### [Production of Coated Active Material]

### (Preparation of Complex Solution)

An amount of 870 g of a 30 mass % hydrogen peroxide solution was put in a container, to which 987 g of ion-exchange water and 177 g of niobic acid (Nb₂O₅·3H₂O (Nb₂O₅ content: 72%)) were added. Next, 87.9 g of 28 mass % ammonia water was added to the container. The contents in the container were sufficiently stirred to give a transparent solution. Then, 40 g of lithium hydroxide monohydrate (LiOH·H₂O) was added to the transparent solution to give a complex solution containing a peroxo complex of niobium and a lithium ion. The molar concentration of Li and that of Nb in the complex solution were each 0.47 mol/kg.

### (Spraying and Drying of Complex Solution)

The complex solution was sprayed onto a positive electrode active material using a tumbling fluidized bed granulation coater (MP-01 manufactured by Powrex Corporation) and was simultaneously dried to form a layer including a precursor of lithium niobium oxide on a surface of each particle of the positive electrode active material. The amount of the complex solution used was 720 g. LiNi_{0.8}Co_{0.15}Al_{0.05}O₂ (NCA; average particle diameter: 5 μm) was used as the positive electrode active material. The amount of the positive electrode active material used was 2000 g. The operation conditions of the tumbling fluidized bed granulation coater were as follows.
Inflow gas: nitrogen
Inflow temperature: 200° C.
Inflow flow rate: 0.4 m³/min
Rotor rotation speed: 400 rotations per minute
Spraying speed: 10 g/min

### (Thermal Treatment)

A thermal treatment of the positive electrode active material coated with the precursor of lithium niobium oxide was performed in a muffle furnace. The thermal treatment conditions are 220° C. and four hours. A coated active material including the positive electrode active material and lithium niobium oxide adhered to the surface thereof was thereby obtained. That is, the coating material of Example 1 was lithium niobium oxide (LiNbO₃).

### (Carbonic Acid Treatment)

The coated active material was placed in a tubular electric furnace. The coated active material was then left to stand still for one hour with carbonic acid gas (CO₂ gas) supplied at a flow rate of 1 L/min so as to bring the carbonic acid gas into contact with the coated active material. A powdery coated active material of Example 1 was obtained in this manner. The purity of the carbonic acid gas was 99.999%.

### [XPS Measurement of Coated Active Material]

XPS measurement of the coated active material of Example 1 was performed under the following conditions. Quantera SXM (manufactured by ULVAC PHI, INC.) was used in the XPS measurement.
X-ray source: Al, monochromatic (25 W, 15 kV)
Electron-ion neutralizing gun: ON
Photoelectron take-off angle: 45 degrees

Carbon (C) was selected as the element to be measured, and the scanning range of binding energy was set to 275 eV to 295 eV (C1s orbital). Peak separation was performed for an XPS spectrum in the range from 275 eV to 295 eV, and the area of each peak was calculated. Specifically, the spectrum was divided to separate a peak attributed to a C—C bond and a peak attributed to an O—C═O bond, and the area (integrated peak area) of each peak was calculated. That is, a proportion r_{C1} of the area of the peak attributed to the O—C═O bond to the total area of the C1s peaks was calculated. The atomic percentage X_{C} of carbon contained in the carbonate ion was calculated by the equation X_{C}=X_{Ctot}×r_{C1}. The atomic percentage X_{C} of carbon contained in CO₃²⁻ was determined by multiplying the proportion of the O—C═O bond by the atomic percentage X_{Ctot} of carbon with respect to all elements (Li, C, O, Al, Co, Ni, and Nb). In analysis of the XPS spectrum, peak fitting was performed with a pseudo-Voigt function. Since a peak position of each bond cannot be determined uniformly due to the effect of electrification, a relative position and a peak intensity ratio of a plurality of peaks of each component were fixed for the fitting.

Niobium (Nb) was selected as the element to be measured, and the scanning range of binding energy was set to 200 eV to 212 eV (Nb3d orbital). The atomic percentage X_{Nb} of Nb was calculated using a Nb3d peak.

A ratio X_{C}/(X_{Nb}+X_{C}) of the atomic percentage X_{C} of carbon contained in the carbonate ion to the sum of the atomic percentage X_{Nb} of Nb and the atomic percentage X_{C} of the carbon contained in the carbonate ion was 0.29.

### [Production of Sulfide Solid Electrolyte]

Li₂S and P₂S₅ were weighed in an argon glove box having an Ar atmosphere having a dew point of −60° C. or lower so that the molar ratio would be Li₂S:P₂S₅=75:25. These were crushed and mixed in a mortar to obtain a mixture. Subsequently, milling of the mixture was performed using a planetary ball mill (Type P-7 manufactured by Fritsch GmbH) at 510 rpm for 10 hours. A solid electrolyte in a glass state was obtained in this manner. The solid electrolyte in a glass state was subjected to a thermal treatment in an inert atmosphere at 270° C. for two hours. Li₂S—P₂S₅ which is a solid electrolyte in a glass ceramic state was thereby obtained.

### [Production of Battery]

### (Production of Positive Electrode)

The coated active material and the sulfide solid electrolyte of Example 1 were weighed so that the ratio of the volume of the coated active material to that of the sulfide solid electrolyte would be 7:3. These were added to a tetrahydroxynaphthalene solvent together with a vapor-grown carbon fiber (VGCF) as a conductive additive and a styrene-ethylene-butylene-styrene block copolymer (SEBS) as a binder. The resulting mixture was sufficiently dispersed with an ultrasonic homogenizer to produce a positive electrode paste. The amount of the conductive additive was 2 parts by mass relative to 100 parts by mass of the coated active material. The amount of the binder was 0.4 parts by mass relative to 100 parts by mass of the coated active material. “VGCF” is a registered trademark of Resonac Corporation.

### (Production of Negative Electrode)

Lithium titanate as a negative electrode active material and the sulfide solid electrolyte were weighed so that the ratio of the volume of the lithium titanate to that of the sulfide solid electrolyte would be 6.5:3.5. These were added to a tetrahydroxynaphthalene solvent together with a vapor-grown carbon fiber (VGCF) as a conductive additive and a styrene-ethylene-butylene-styrene block copolymer (SEBS) as a binder. The resulting mixture was sufficiently dispersed with an ultrasonic homogenizer to produce a negative electrode paste. The amount of the conductive additive was 1 part by mass relative to 100 parts by mass of the negative active material. The amount of the binder was 2 parts by mass relative to 100 parts by mass of the negative active material.

(Production of all-Solid-State Battery)

The positive electrode paste was applied to an aluminum foil serving as a positive electrode current collector by blade coating using an applicator to form a coating film. The coating film was dried on a hot plate at 100° C. for 30 minutes. A positive electrode including the positive electrode current collector and the positive electrode active material layer was obtained in this manner.

Next, the positive electrode was pressed. A paste for electrolyte layer formation was applied to a surface of the pressed positive electrode active material layer with a die coater to give a layered body composed of the positive electrode and the coating film, the paste including the sulfide solid electrolyte. The layered body was dried on a hot plate at 100° C. for 30 minutes. After that, the layered body was roll-pressed at a linear pressure of 2 tons/cm. A layered body to be on the positive electrode side was obtained in this manner, the layered body including the positive electrode current collector, the positive electrode active material layer, and a solid electrolyte layer.

The negative electrode paste was applied to a nickel foil serving as a negative electrode current collector to form a coating film. The coating film was dried on a hot plate at 100° C. for 30 minutes. A negative electrode including the negative electrode current collector and the negative electrode active material layer was obtained in this manner.

Next, the negative electrode was pressed. The paste for electrolyte layer formation was applied to a surface of the pressed negative electrode active material layer with a die coater to give a layered body composed of the negative electrode and the coating film. The layered body was dried on a hot plate at 100° C. for 30 minutes. After that, the layered body was roll-pressed at a linear pressure of 2 tons/cm. A layered body to be on the negative electrode side was obtained in this manner, the layered body including the negative electrode current collector, the negative electrode active material layer, and a solid electrolyte layer.

Each of the layered body to be on the positive electrode side and the layered body to be on the negative electrode side was subjected to punching processing to give a piece in a given shape. The pieces of the layered body to be on the positive electrode side and the layered body to be on the negative electrode side were stacked such that the solid electrolyte layers thereof were in contact with each other. After that, the pieces of the layered body to be on the positive electrode side and the layered body to be on the negative electrode side were roll-pressed at 130° C. and a linear pressure of 2 tons/cm. A power generation element including the positive electrode, the solid electrolyte layer, and the negative electrode in this order was obtained in this manner. A positive electrode terminal and a negative electrode terminal were attached to the power generation element, which was put into a container made of a laminate film. The container was sealed, and was held tightly under a pressure of 5 MPa. An all-solid-state battery of Example 1 was obtained in this manner.

### [DC Resistance Measurement]

The all-solid-state battery was measured for its DC resistance by the following method. Constant current charging was performed at a current of 1C. After the cell voltage reached 2.95 V, constant voltage charging was performed at 2.95 V. At the moment when the charging current reached 0.01C, the charging was finished. Subsequently, constant current discharging was performed at a current of 1C. At the moment when the cell voltage decreased to 1.5 V, the discharging was finished.

To measure the DC resistance, the all-solid-state battery was charged again to 2.2 V at a current of C/3 and was then discharged at a current of 4C. A difference between an open-circuit voltage immediately before the discharging at 4C and a voltage 10 seconds after the start of the discharging was divided by a current value corresponding to 4C to calculate the DC resistance. The resulting DC resistance was defined as an initial resistance before a durability test. Table 1 and FIG. 4 show the results.

In Table 1 and FIG. 4, the initial resistance is a relative value relative to the initial resistance of Comparative Example 1 defined as 100. FIG. 4 is a graph showing a relation between X_{C}/(X_{Nb}+X_{C}) and the initial resistance and a relation between X_{C}/(X_{Nb}+X_{C}) and a resistance change rate. The horizontal axis indicates the value of X_{C}/(X_{Nb}+X_{C}). The vertical axis indicates the initial resistance and the resistance change rate as percentages of those of Comparative Example 1.

### [Durability Test]

The all-solid-state battery was placed in a constant-temperature chamber at 60° C., and a charge-discharge cycle test was performed to evaluate the electrochemical durability of the all-solid-state battery. First, constant current charging was performed at a current of 5C until a maximum voltage 2.7 V was reached. After that, constant voltage charging was performed until the current attenuated to ⅓. Next, constant current discharging was performed at a current of 1C until a minimum voltage 1.8 V was reached. This charge-discharge cycle was repeated 90 times as a durability test. A small increase of the resistance in the durability test means that the battery has excellent cycle characteristics.

After the durability test, DC resistance measurement was performed by the above-described method, and a DC resistance after the durability test was calculated. The resistance change rate in the durability test was calculated by the following equation (6). Table 1 and FIG. 4 show the result. In Table 1 and FIG. 4, the resistance change rate is a relative value relative to the resistance change rate of Comparative Example 1 defined as 100.

$$( Resistance change rate ) = 100 \times \{ ( DC resistance after durability test ) / ( Initial resistance ) \} / \{ ( DC resistance of Comparative Example 1 after durability test ) / ( Initial resistance of Comparative Example 1 ) \} \qquad ( 6 )$$

### Example 2

A coated active material of Example 2 was produced in the same manner as in Example 1, except that carbonic acid treatment was performed under the following conditions.

### (Carbonic Acid Treatment)

The coated active material was placed in a tubular electric furnace. Then, while carbonic acid gas was being supplied at a flow rate of 1 L/min, the temperature inside the tubular electric furnace was risen to 100° C. at 5 K/min and was held at 100° C. for one hour. After that, the coated active material was slowly cooled until the temperature inside the tubular electric furnace decreased to room temperature. A powdery coated active material of Example 2 was obtained in this manner.

### Examples 3 to 6

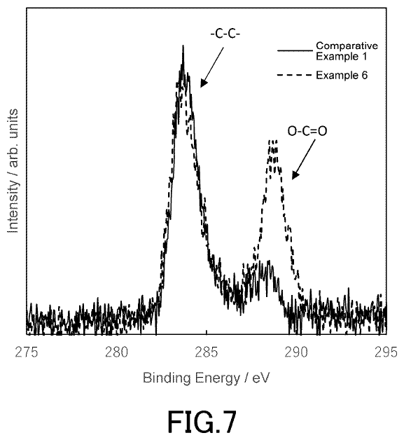

Coated active materials were produced in the same manner as in Example 2, except that carbonic acid treatment was performed under the following conditions. FIG. 7 shows a C1s XPS spectrum of a coated active material of Example 6.

### (Carbonic Acid Treatment)

Each coated active material was placed in a tubular electric furnace. Then, while carbonic acid gas was being supplied at a flow rate of 1 L/min, the temperature inside the tubular electric furnace was risen to a given temperature at 10 K/min and was held at the given temperature for one hour. After that, the coated active material was cooled to near room temperature. Powdery coated active materials of Examples 3 to 6 were obtained in this manner. The given temperature for Example 3 was 150° C. The given temperature for Example 4 was 250° C. The given temperature for Example 5 was 300° C. The given temperature for Example 6 was 350° C.

### Comparative Example 1

A coated active material of Comparative Example 1 was produced in the same manner as in Example 1, except that the carbonic acid treatment was omitted. FIG. 7 shows a C1s XPS spectrum of the coated active material of Comparative Example 1.

Table 1 shows the ratio X_{C}/(X_{Nb}+X_{C}), the initial resistance, and the resistance change rate of the coated active materials of Examples 2 to 6 and Comparative Example 1 as for Example 1.

TABLE 1

| | Carbonic | | Initial | Resistance |
|---|---|---|---|---|
| | acid | | resistance | change |
| | treatment | X_{C}/(X_{Nb} + X_{C}) | (%) | rate (%) |
| Example 1 | 25° C. | 0.29 | 96 | 95 |
| Example 2 | 100° C. | 0.34 | 93 | 95 |
| Example 3 | 150° C. | 0.44 | 90 | 97 |
| Example 4 | 250° C. | 0.45 | 86 | 90 |
| Example 5 | 300° C. | 0.56 | 91 | 93 |
| Example 6 | 350° C. | 0.67 | 141 | 99 |
| Comparative | N/A | 0.28 | 100 | 100 |
| Example 1 | | | | |

*The initial resistance and the resistance increase rate were relative values relative to those of Comparative Example 1 defined as 100.

### DISCUSSION

In Comparative Example 1, the ratio X_{C}/(X_{Nb}+X_{C}) was 0.28. As the results for Examples 1 to 6 show, the carbonic acid treatment at room temperature or a temperature higher than room temperature increased the ratio X_{C}/(X_{Nb}+X_{C}). That is, the atomic percentage of the carbon contained in the carbonate ion increased. According to Examples 1 to 5, the carbonic acid treatment not only improved the resistance change rate but also decreased the initial resistance of each battery. Achievement of this result is presumably due to the following reason. When a positive electrode active material has been synthesized, lithium that did not contribute to the reaction remains, for example, as Li₂O on the surface of the particle of the positive electrode active material. A lithium compound such as Li₂O absorbs moisture and/or carbon dioxide in air, and thereby compounds such as LiOH and/or LiHCO₃ are generated. These compounds are electrochemically unstable and active. The carbonic acid treatment stabilizes such compounds by changing the compounds to Li₂CO₃. This is thought to be how a side reaction inside the battery was suppressed and the initial resistance of the battery decreased.

The reducing effects on the initial resistance and the resistance change rate reached maximum at 250° C., and the ratio X_{C}/(X_{Nb}+X_{C}) at that moment was 0.45. When the ratio X_{C}/(X_{Nb}+X_{C}) exceeded 0.45, the initial resistance and the resistance change rate showed an increasing trend. This is presumably because an increase in thickness of the layer (carbonate layer) including the carbon contained in the carbonate ion prevented ionic conduction. As for Example 6, the resistance change rate decreased, but the initial resistance increased, compared to Comparative Example 1.

### [Evaluation of Thickness of Layer (Carbonate Layer) Including Carbon Contained in Carbonate Ion]

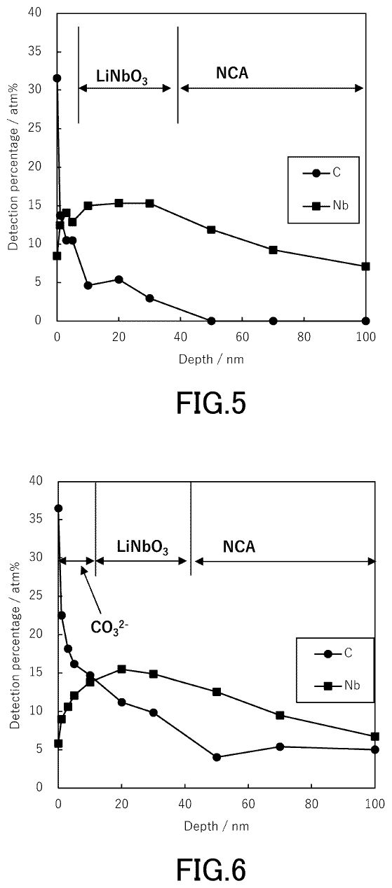

Each of the coated active materials of Comparative Example 1 and Example 4 was subjected to argon etching to remove elements on the surface thereof. XPS measurement was performed each time a predetermined etching time had passed so as to obtain a profile of elemental concentrations. A relation between the etching time and the etching depth was obtained by etching a thin SiO₂ film having a known thickness. Using the relation between the etching time and the etching depth, the thickness of the carbonate layer was calculated in terms of SiO₂ thickness from the etching time. FIGS. 5 and 6 show the results.

FIG. 5 is a graph showing an elemental profile of the coated active material of Comparative Example 1 in the depth direction. The detected elements are carbon and niobium. The horizontal axis indicates the depth from the surface. The vertical axis indicates the atomic percentages of carbon and niobium with respect to all elements. For Comparative Example 1, the niobium concentration was almost constant from the surface to a depth of 30 nm. The niobium concentration gradually decreased in a region deeper than 30 mm. It is thought that LiNbO₃ was present from the surface to a depth around 30 nm and that etching deeper than 30 nm formed a portion lacking the coating material layer, weakening a signal.

FIG. 6 is a graph showing an elemental profile of the coated active material of Example 4 in the depth direction. The niobium concentration was low and the carbon concentration was high near the surface. That is, the layer including the carbon contained in the carbonate ion was in the surface of the coated active material. The carbon rate sharply decreased from the surface to a depth around 20 nm. Then, the carbon rate gradually decreased. Since the niobium rate reached maximum at 20 nm, it is thought that the thickness of the carbonate layer was at least approximately 20 nm in terms of SiO₂. The carbon rate was constant from a depth of 50 nm. This indicates that the thickness of the carbonate layer was approximately 50 nm at maximum. It is thought that the thickness of the carbonate layer increases with increasing treatment temperature in the carbonic acid treatment and with increasing treatment time in the carbonic acid treatment.

In the case of etching a powdery specimen, carbon at a face orthogonal to an etching beam disappears relatively early. Carbon at a face parallel to an etching beam less easily disappears. For Comparative Example 1 (FIG. 5), a signal of carbon disappeared when the etching proceeded to a certain depth. This indicates a very small amount of carbon in the surface. On the other hand, for Example 4 (FIG. 6), a signal of carbon did not disappear in the course of the etching and settled at a certain value.

### INDUSTRIAL APPLICABILITY

The battery of the present disclosure can be used, for example, as an all-solid-state secondary battery.

What is claimed is:

1. A coated active material comprising:
a positive electrode active material; and
a coating material coating at least a portion of a surface of the positive electrode active material, wherein
the coating material comprises a compound represented by the following composition formula (1) and carbon attributed to a C1s peak having a binding energy of 288.5±1.5 eV:
LiₐM_{b}O_{c} (1),
where a, b, and c are each a positive real number, and M is at least one element other than Li or O, and
in a surface of the coated active material, an atomic percentage X_{C} of the carbon and an atomic percentage X_{M} of the M satisfy a relation represented by the following inequality (2):
$$0.29 \leq {X}_{C} / ( {X}_{M} + {X}_{C} ) . \qquad ( 2 )$$

2. The coated active material according to claim 1, wherein the atomic percentage X_{C} and the atomic percentage X_{M} satisfy a relation represented by the following inequality (3):
$$0.29 \leq {X}_{C} / ( {X}_{M} + {X}_{C} ) < 0.67 . \qquad ( 3 )$$

3. The coated active material according to claim 1, wherein the carbon is distributed in a region extending from a surface of the coated active material to a depth of 50 nm or less.

4. The coated active material according to claim 1, wherein the M is at least one element selected from the group consisting of a metal element and a metalloid element.

5. The coated active material according to claim 1, wherein the M is in a trivalent state, a tetravalent state, a pentavalent state, or a mixed state of these.

6. The coated active material according to claim 1, wherein the M comprises niobium.

7. The coated active material according to claim 1, wherein the M comprises at least one selected from the group consisting of nitrogen, sulfur, and phosphorus.

8. The coated active material according to claim 1, wherein the positive electrode active material comprises a lithium-containing transition metal oxide having a layered rock-salt structure.

9. A battery comprising a positive electrode comprising the coated active material according to claim 1.

10. A battery comprising:
a positive electrode comprising the coated active material according to claim 1;
a negative electrode; and
an electrolyte layer disposed between the positive electrode and the negative electrode.

11. The battery according to claim 10, wherein the electrolyte layer comprises a sulfide solid electrolyte.

12. A coated active material manufacturing method comprising:
coating a positive electrode active material with a coating material; and
bringing the positive electrode active material coated with the coating material into contact with a treatment gas comprising carbonic acid gas at a higher concentration than in air.

13. The coated active material manufacturing method according to claim 12, further comprising heating the positive electrode active material coated with the coating material while the positive electrode active material is in contact with the treatment gas.

14. The coated active material manufacturing method according to claim 12, wherein a main component of the treatment gas is the carbonic acid gas.
